(19) United States
(12) Patent Application Publication
(10) Pub. No.: US 2006/0255611 A1
(43) Pub. Date: Nov. 16, 2006

(54) Load floor system

(75) Inventors: Nels R. Smith, Zeeland, MI (US); Rollin E. Nothwehr, Holland, MI (US); Brian R. Dexter, Grand Haven, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/432,300

(22) Filed: May 11, 2006

Related U.S. Application Data
(60) Provisional application No. 60/680,298, filed on May 12, 2005.

(51) Int. Cl. B60R 7/04

(52) U.S. Cl. 296/37.16

(57) ABSTRACT

A load floor system is disclosed for use within a cargo area defined by a plurality of vehicle interior components and reconfigurable between a first storage configuration and a second storage configuration. The load floor system comprises a first load floor, a second load floor separate from the first load floor, and a covering coupled to the first load floor and the second load floor. The cargo area in the first storage configuration includes the first cargo floor and the cargo area in the second storage configuration includes the first cargo floor and the second cargo floor. The first cargo floor is presented without the second cargo floor when the cargo area is in the first storage configuration, and the first cargo floor is presented with the second cargo floor when the cargo area is in the second storage configuration. The covering provides a continuous surface between the first load floor and the second load floor. The first load floor and the second load floor each includes a base configured to provide structural support to the covering disposed above the respective load floor.

### CROSS REFERENCE TO RELATED APPLICATION

The present application claims priority under 35 U.S.C. § 119 from U.S. Provisional Patent Application No. 60/680,298 titled “LOAD FLOOR SYSTEM” filed May 12, 2005 (Attorney Docket No. 026032-4911), the full disclosure of which is hereby incorporated herein by reference.

### BACKGROUND

The present inventions relate to a reconfigurable load floor for a vehicle. The present inventions more specifically relate to a continuous surface provided on a reconfigurable load floor in a vehicle.

It is known to provide for a load floor in a cargo area of a vehicle. Such known load floors are typically located in the vehicle's cargo area, which is typically defined by a tail gate or door, side trim panels, and the backs of a row of seats. Such known load floors typically include a floor panel and a covering attached to the floor panel. The cargo areas may be enlarged or expanded by folding down the row of seats such that the backs of the seats also provide an additional load floor within the expanded cargo area. Such seats typically include a seat back panel and a covering attached to the seat back panel. Thus, coverings in known vehicles are separately attached to the respective floor panel or seat back panel. When the seats are folded forward to provided the enlarged cargo area condition, a gap exists at the interface between the “first” load floor (provided by the floor panel and its covering) and the “second” load floor (provided by the seat back panel and its covering). Some known vehicles include a panel (sometimes known as a “follower”) that intends to cover the gap between the first load floor and the second load floor. However, such known separate coverings do not realize certain advantageous features (and/or combinations of features). For example, such gaps allow objects to fall between the load floors, less load floor support surface, and an undesirable appearance.

Accordingly, it would be advantageous to provide a continuous load floor system. It would be desirable to provide a load floor that provides a configurable and reconfigurable load floor for a vehicle. It would also be desirable to provide a load floor that provides a continuous or seamless surface for the load floor. It would further be desirable to provide a load floor that provides a continuous surface that can be printed on (ornamental and functional indicia). It would further be desirable to provide a load floor that reduces the spaces or gaps where articles may fall into or through. It further would be desirable to provide a load floor that reduces cost through capital elimination and part integration. It would be desirable to provide for a load floor system having one or more of these or other advantageous features. To provide an inexpensive, reliable, and widely adaptable load floor system that avoids the above-referenced and other problems would represent a significant advance in the art.

### DESCRIPTION OF THE DRAWINGS

FIG. 1 is a perspective view of a load floor system according to a preferred embodiment. A portion of the load floor system is coupled to a row of seats that are in an upright or deployed position.

FIG. 2 is a perspective view of the load floor system of FIG. 1 with the seat backs in a down or stowed position.

FIG. 3 is a perspective view of the load floor system of FIG. 2 with the row of seats being configured for split seat arrangement.

FIG. 4 is the load floor system of FIG. 3 in the process of being mounted within a vehicle and prior to one of the load floors and/or covering being coupled to seat backs.

FIG. 5 is the load floor system of FIG. 5 with a portion of a load floor and/or covering pivoted upright to expose a protective surface with elements in the form of divider organization.

FIG. 6 shows three exemplary coverings with indicia or other functional or ornamental attachments.

FIG. 7 is a load floor system according to an exemplary embodiment and having a storage bin forming a portion of the base of one of the load floors with a lid rotated upright to provide access to storage within the subfloor storage compartment.

FIG. 8 is a perspective view of a load floor system according to an exemplary embodiment when the seat (frame) are in the upright or deployed position.

FIG. 9 shows the load floor system of FIG. 8 with the second load floor being pivoted from the upright position toward the down or stowed position.

FIG. 10 is a side elevation view of the load floor system of FIG. 8 with the seat backs in the stowed or down position (substantially horizontal in this embodiment).

FIG. 11 shows a series of images showing a load floor system with a large gap between the seat back and the load floor as it is being pivoted from down or stowed position to the upright or deployed position.

FIG. 12 includes a series of images showing the seat back as is pivoted from the down toward the upright position where there is a small gap between the seat back and the rear load floor.

FIG. 13 shows an exploded views of a load floor system according to an exemplary embodiment.

FIG. 14 shows a fragmentary perspective view of a covering folded according to an exemplary embodiment when the seats are in their upright position.

FIG. 15 is a load floor system according to an exemplary embodiment with a modular cargo management system.

FIG. 16 is the load floor system of FIG. 15 with panels rotated for an exemplary cargo management arrangement.

FIG. 17 is the load floor system of FIG. 15 with panels rotated for an exemplary cargo management arrangement.

### SUMMARY

The present invention is directed to a load floor system for use within a cargo area that is reconfigurable between a first storage configuration and a second storage configuration. The load floor system comprises a first load floor, a second load floor separate from the first load floor, and a covering coupled to the first load floor and the second load floor. The cargo area in the first storage configuration includes the first cargo floor and the cargo area in the second storage configuration includes the first cargo floor and the second cargo floor. The first cargo floor is presented without the second cargo floor when the cargo area is in the first storage configuration, and the first cargo floor is presented with the second cargo floor when the cargo area is in the second storage configuration. The covering provides a continuous surface between the first load floor and the second load floor. The first load floor and the second load floor each includes a base configured to provide structural support to the covering disposed above the respective load floor.

The present invention relates to a load floor system for a vehicle having a cargo area and a seat adjacent the cargo area. The load floor system comprises a first load floor located in the cargo area; a second load floor separate from the first load floor and coupled to the seat and movable between a first position and a second position; and a covering coupled to the first load floor and to the second load floor, and configured to provide a continuous surface between the first load floor and the second load floor.

The present invention also relates to a vehicle interior comprising a seat movable between an upright position and a stowed position; a cargo area defined at least in part by a first cargo floor; and a covering coupled to the first cargo floor and to a back surface of the seat and configured to provide a continuous surface between the first load floor and the second load floor. A first cargo configuration is provided when the seat is in the upright position. A second cargo configuration is provided when the seat is in the stowed position and the back surface of the seat is configured to provide a second load floor.

The present invention further relates to a load floor system for a vehicle having a cargo area and a seat adjacent the cargo area. The load floor system comprises a first load floor located in the cargo area; a second load floor separate from the first load floor and coupled to the seat and movable between a first position and a second position; and a covering coupled to the first load floor and to the second load floor, and configured to provide a continuous surface between the first load floor and the second load floor; and to fold upon itself at an interface between the first load floor and the second load floor when moved between the second position and the first position. The first load floor, the second load floor, and the covering are configurable in a first storage configuration, wherein the second load floor is in the first position and storage space is provided by the first cargo floor, and a second storage configuration, wherein the second load floor is in the second position and storage space is provided by both the first cargo floor and the second cargo floor.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### OUTLINE OF CERTAIN ELEMENTS AND ASSEMBLIES

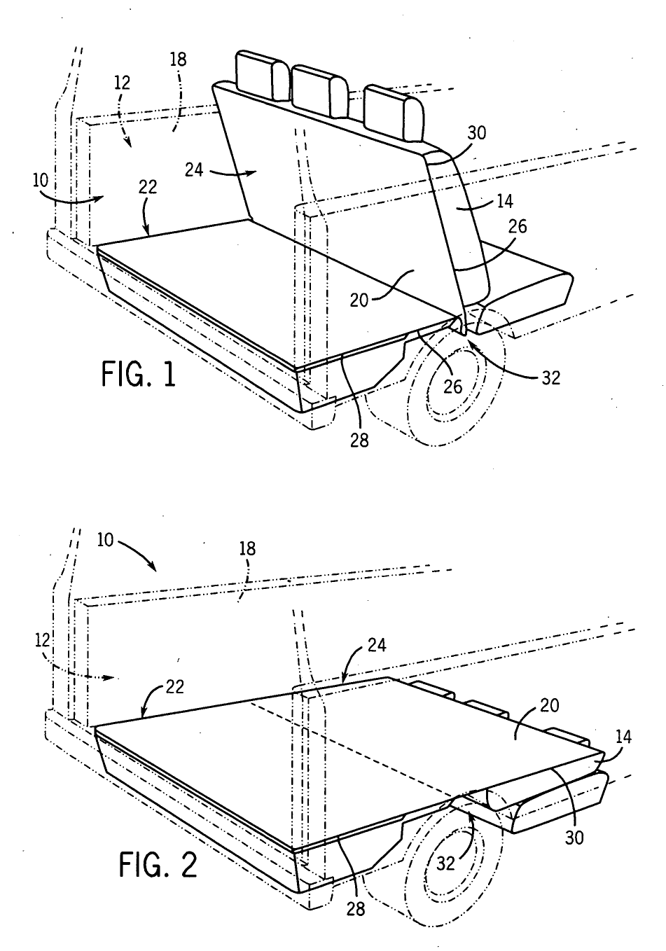

An exemplary embodiment of a load floor system 10 for a vehicle cargo area 12 is shown in FIGS. 1 and 2. FIG. 1 is a perspective view of load floor system 10 according to a preferred embodiment. A portion of the load floor system is coupled to a row of seats 14 that are in an upright or deployed position. FIG. 2 is a perspective view of the load floor system 10 of FIG. 1 with the row of seats 14 in a down or stowed position. The cargo area 12 is generally defined by a tail gate or door (not shown), side trim panels 18, and backs 20 of the row of seats. The cargo area 12 may be enlarged or expanded by folding down the row of seats (e.g., configured, reconfigured, etc.). According to alternative embodiments, cargo areas may be defined by any of a variety of vehicle interior components.

The load floor system 10 includes a first (e.g., primary, initial, original, etc.) load floor 22 located within the cargo area, a second (e.g., secondary, additional, etc.) load floor 24 within the expanded cargo area, and a covering 26 coupled to the first load floor and the second load floor. The first load floor 22 includes a base (shown as a floor panel 28) to provide structural support for a portion of the cargo area. The second load floor includes a base (shown as a seat back panel 30) coupled to the seat back(s) to provide structural support for a portion of the expanded cargo area.

According to exemplary embodiments, the covering 26 provides a continuous surface across an interface 32 between the first load floor 22 and the second load floor 24 when the seats 14 are folded forward to provide the enlarged cargo area. The covering 26 is coupled to the floor panel 28 and the seat back panel 30. The covering may be carpet, plastic sheet, or the like. The covering may be a single integral component or comprised of several connected sheets or strips. According to exemplary embodiments, the covering includes selective breaks (e.g., scoring, grooves, recesses, etc.) to create on or more hinges.

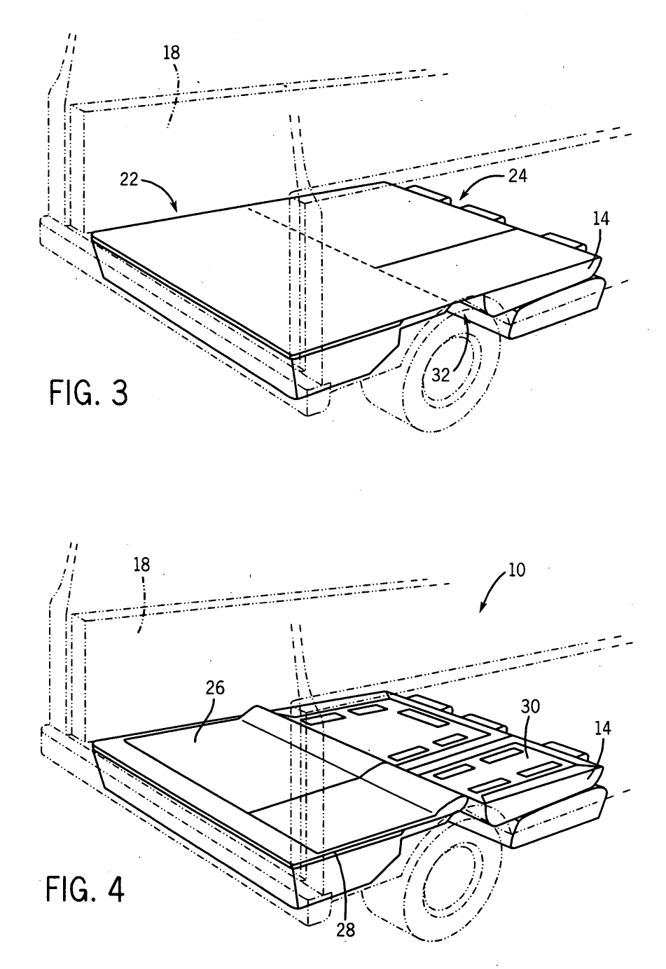

FIG. 3 is a perspective view of the load floor system of FIG. 2 with the row of seats being configured for split arrangement. The seat backs in this view are shown in the upright position. The row of seats may selectively fold (e.g., 60/40 split, 50/50 split or other arrangement). According to an alternative embodiment, the entire load floor system can be split (e.g., seatbacks, storage areas, storage area lids, etc.). The seat back panel and a portion of the covering coupled to the seat back panel are likewise split to allow for one or both of the seats to be folded over to provided the expanded cargo area.

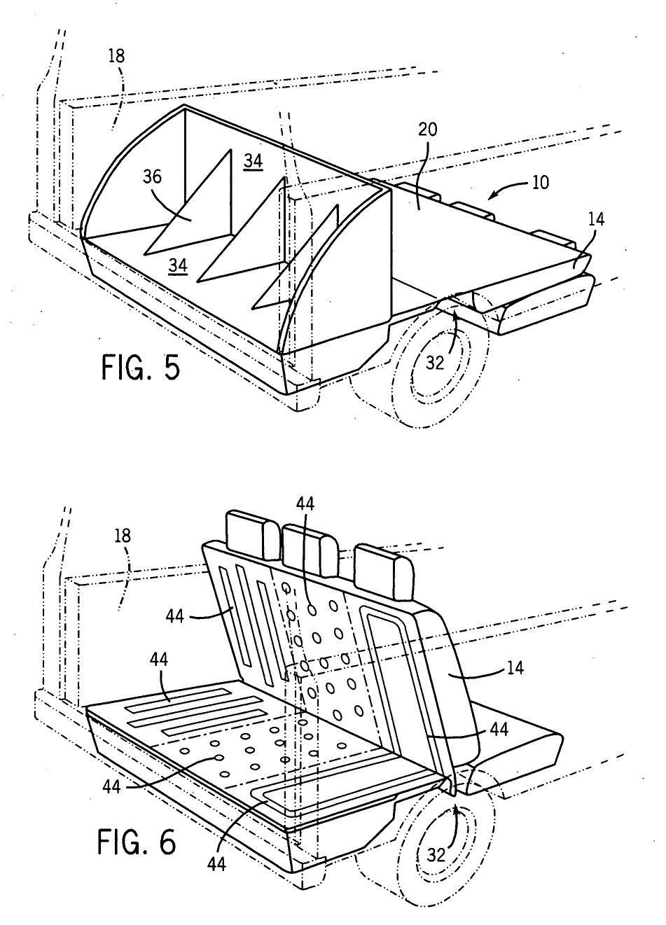

FIGS. 3 and 4 show a load floor system according to a preferred embodiment being installed in a vehicle and in various positions or configurations. The covering (shown as carpet) rotates (e.g., pivots, flips, folds, etc.) and attaches to the trim sidewall and/or seat back panel 30. FIG. 4 is a perspective view of the load floor system having a covering that can be pivoted and retained in a upright position. According to a preferred embodiment, the covering may be pivoted to reveal a secondary load or protective surface 34 (e.g., made of a durable material to resist damage to the load floor, to the articles stored in the cargo area, etc.) and dividers 36. FIG. 5 also shows an exemplary embodiment of the protective surface in the form of a water-proof layer added to the backside of the covering to create a contained wet/dirt area.

FIG. 4 is the load floor system of FIG. 3 prior to one of the load floors being coupled to seat backs. The load floor system may be coupled to the seats before or after being installed within the vehicle. For example, the covering can be coupled to the seat back panels and seats and then the this assembly is installed in the vehicle. The load floor system and seats can be shipped to the customer coupled together or shipped separately then coupled together by the customer before installation into the vehicle. Alternatively, the load floor system and the seats are separately installed in the vehicle (in any order or sequence) and then coupled together. FIG. 3 is the load floor system 40 of FIG. 4 mounted within the vehicle and coupled to the seat backs 20.

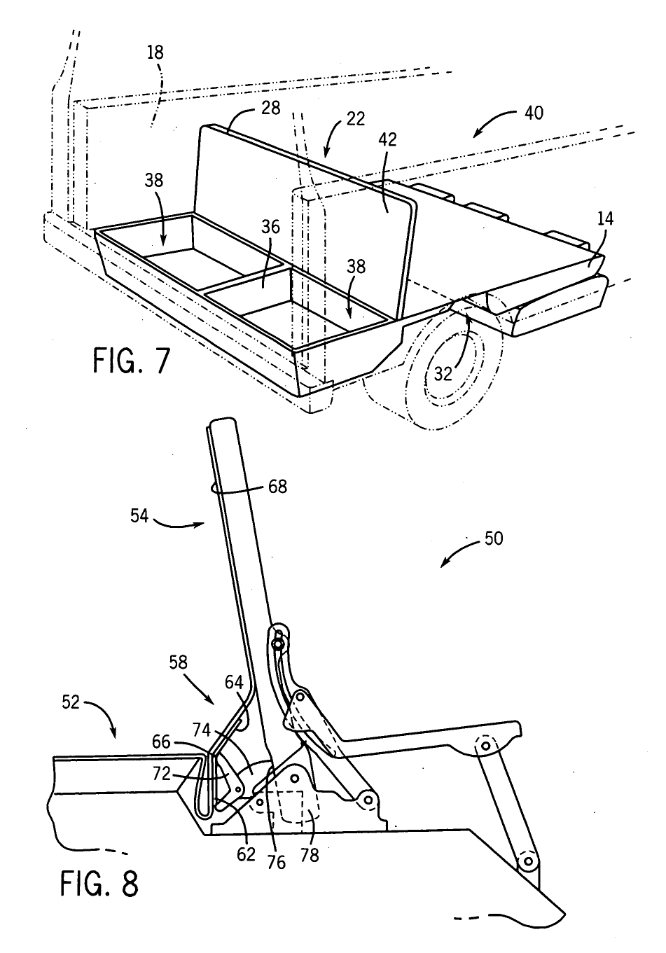

FIGS. 5 and 7 show load floor systems having a supplemental storage configuration, (e.g., bin, compartment, unit, organization system, etc.) located below the second load 24. Generally, the storage area is accessed by lifting (e.g., rotating, pivoting, removing, etc.) the second load floor 24.

FIG. 5 is the load floor system of FIG. 2 with a portion of the covering 26 pivoted upright to expose the protective surface 34. The protective surface (e.g., water-proof) is preferably also added to the backside of the covering (i.e., the carpet “tile”) to create a contained wet/dirt area.

FIG. 7 shows a load floor system 40 having a storage bin 38 forming a portion of the base of one of the load floors. The load floor system 40 is shown prior to mounting within a vehicle. The load floor system 40 includes a floor panel 28, a seat back panel 30, a covering 26, and a storage area defined by the bin 38. According to a preferred embodiment, the floor panel includes a lid 42 is coupled to the bin by a hinge (e.g., living hinge, piano hinge, etc.) and serves as the removable lid to the storage area. The lid 42 is rotated upright to provide access to storage area within the subfloor storage compartment. The load floor 22 is movable (e.g., rotated, pivoted, slid, opened, etc.) to provide access to the storage area. The storage area may be a single space or be divided (e.g., by stationary or moveable or modular dividers or panels 36) into two or more storage spaces as shown in FIG. 7.

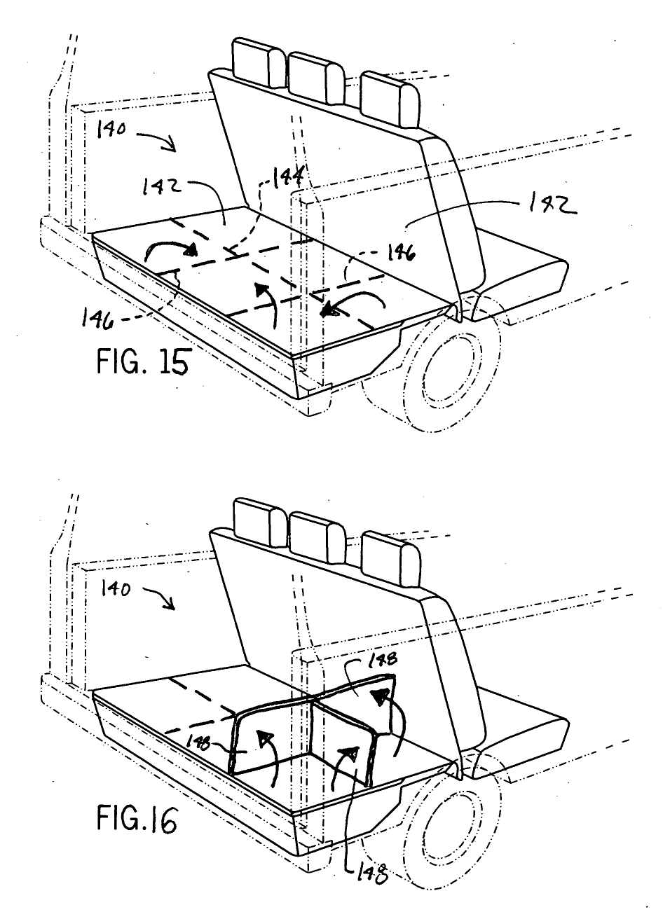

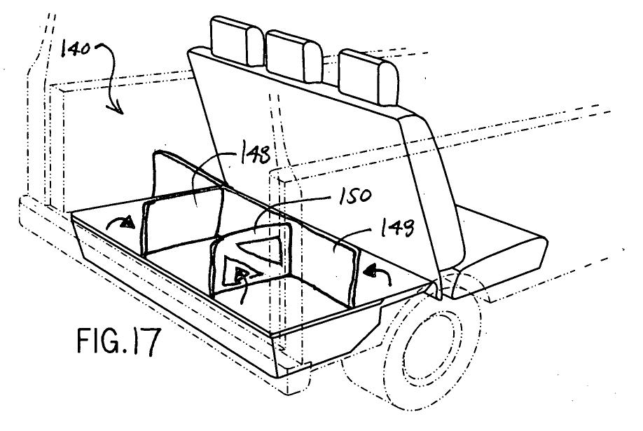

FIG. 15 is a load floor system 140 according to an exemplary embodiment as a modular cargo management system. A covering 142 is divided by a plurality of hinges 144, 146 formed in the carpet to provide a plurality of panels 148, shown as fore/aft panels and cross-car panels, that are preferably fabricated into the load floor covering and may be used as a cargo divider (e.g., for temporary storage). Configuring (e.g., reconfiguring, positioning, repositioning, rotating, pivoting, etc.) the panels provides a variety of cargo management configurations. FIG. 16 is the load floor system of FIG. 15 with panels rotated for an exemplary cargo management arrangement. FIG. 17 is the load floor system of FIG. 15 with panels rotated for another exemplary cargo management arrangement. Preferably, panels are coupled together by a snap through fastener, which is provided by a projection (e.g., male snap portion) being inserted through an aperture to engage a receptacle (e.g., female snap portion). As shown in FIG. 17, the panels are preferably reinforced with injection molded brackets 150.

FIGS. 1 and 6 show the load floor systems with the row of seats 14 in their upright or use positions. The second load floor 24 spans the back 20 of the seats 14. According to an exemplary embodiment, a portion of the covering 26 that is not attached to either the seat back panel or the floor panel is allowed to hang down (e.g., drape, fold, sag, etc.) at or between the interface 32 between the seats 14 and the initial cargo area (e.g., in a gap, recess, etc.).

According to a particularly preferred embodiment shown in FIG. 6, the continuous covering 26 allows for indicia 44 to be applied to the covering (e.g., printed, etched, added, etc.). FIG. 6 shows exemplary load floor systems wherein the covering includes indicia or other functional or ornamental attachments. Such indicia may be ornamental (patters, textures, etc.) or be functional (e.g., instructive, wear-resistant, durability, etc.).

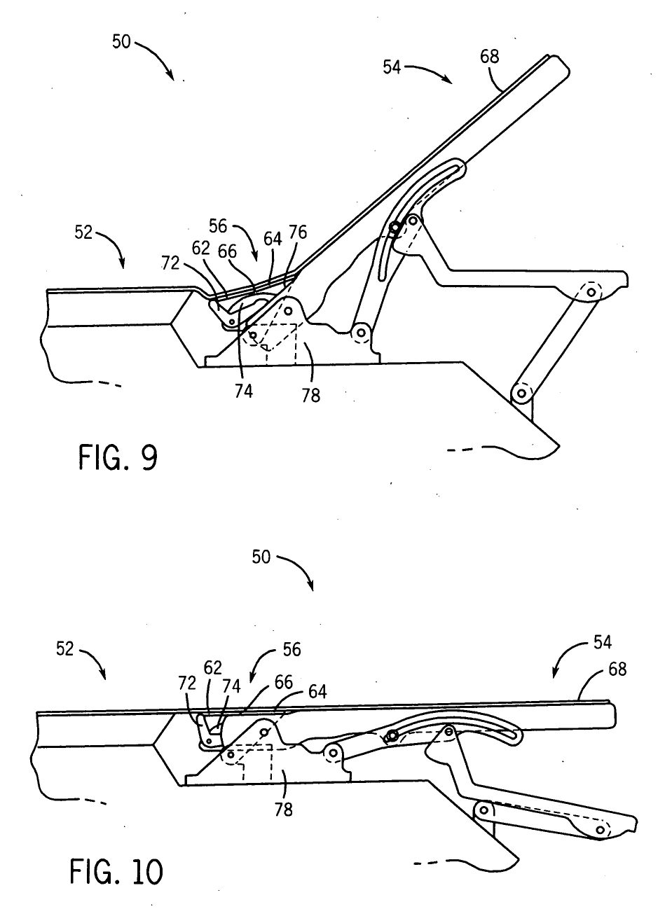

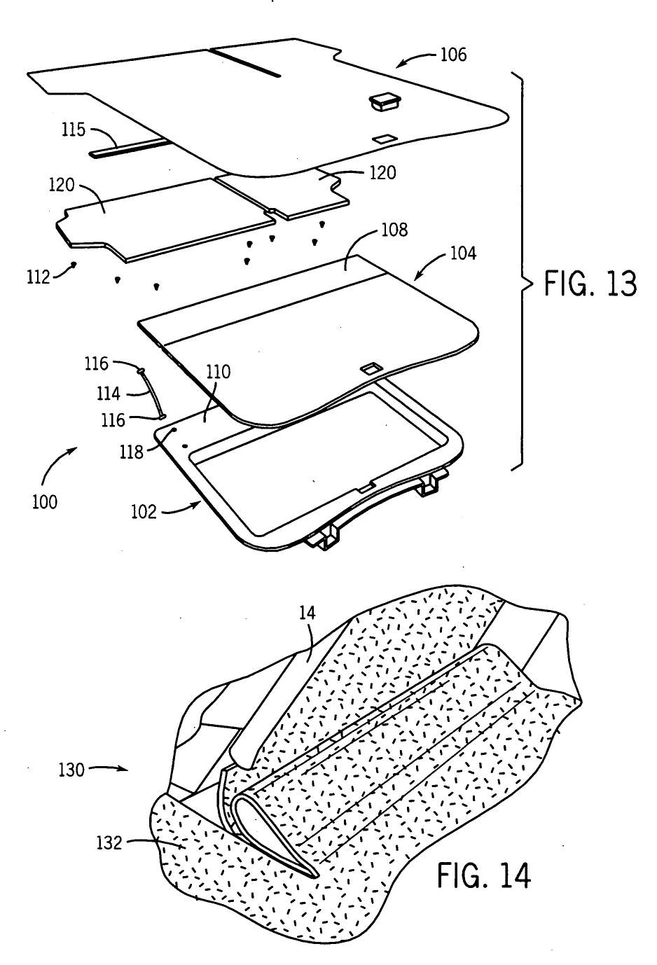

Referring to FIGS. 8-10, a load floor system 50 is shown according to an exemplary embodiment. The load floor system 50 includes a first load floor 52, a second load floor 54, and an intermediate (e.g., third, middle, etc.) load floor 56 disposed between the first load floor and the second load floor. According to an exemplary embodiment shown in FIGS. 13, 14, and 19, the second load floor is coupled to a seat frame 58 and a seat pivot mechanism 60.

Referring to FIG. 8, the intermediate load floor 56 includes a first portion 62 and a second portion 64. According to an exemplary embodiment, the first portion 62 is coupled to the second portion 64 by a hinge 66. According to a preferred embodiment, the first portion 62 is integrally formed with the second portion 64. For example, the hinge 66 may be a living hinge formed during a molding operation. Alternatively, a machining operation (e.g., scoring or creating a groove in a panel, etc.) may be used to provide for the portions to pivot with respect to each other. The intermediate load floor 56 is coupled to the vehicle (e.g., to a base of the seats) by a pivoting bracket 72 (e.g., support, brace, etc.). Preferably, the pivoting bracket 72 is coupled to the second portion 64 of the intermediate load floor 56 and to a support base 74 coupled to the vehicle. A covering 68 is coupled the first portion 62 of the intermediate load floor 56. Preferably, the covering 68 is not directly attached to the second portion 64 to allow relative movement between the covering and the second portion 64 of the intermediate load floor 56.

Referring to FIG. 10, the first portion 62 of the intermediate load floor 56 provides structural support to the covering 68 in a gap or space 70 between the first load floor 52 and the second load floor 54 (and any objects placed between the first load floor and the second load floor) when the seats are in a deployed or use position (e.g., upright). The second portion 64 of the intermediate load floor 56 and the covering 68 hang down (e.g., project, droop, sag, etc.) below the interface between the first load floor and the second load floor.

Referring to FIG. 10, the first portion 62 and the second portion 64 of the intermediate load floor 56 provide structural support to the covering 68 between the first load floor 52 and the second load floor 54 (and any objects placed between the first load floor and the second load floor) when the seats are in the stowed position (e.g., folded forward). Structural support to the first and second portions of the intermediate load floor is provided by the bracket 72 and its base 74, and by a lower portion 76 of the seat frame 58 and its base 78. As the seats are moved toward the stowed position, the first portion 62 and the second portion 64 engage (e.g., slide along) the bracket 72 and its base 74, and by a lower portion 76 of the seat frame 58 and its base 78. When the seats are in the stowed position, the intermediate load floor 56 is generally in the same plane as the first load floor 52 and the second load floor 54.

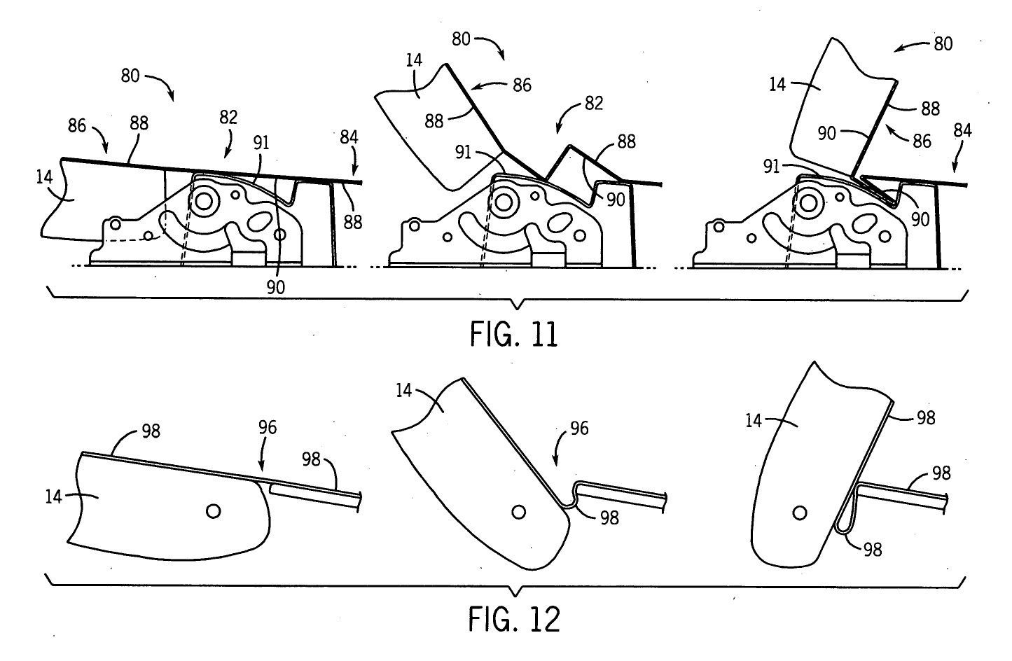

A gap 70 may occur between the first load floor 52 and the second load floor 54 (when seats are folded forward) or the seat back (when the seats are upright). A load floor system 80 with a larger gap 82 is shown in FIG. 11. System 80 includes a first load floor 84, and a second load floor 86, and a covering 88. The covering 88 is reinforced with a structural backing 90 and/or a support member 91. This backing 90 is intended to supply strength to the covering area or portion 92 that bridges across the underlying support structure or base (i.e., first load floor 84 and second load floor 86). The covering 88 (e.g., carpet) would then fold in a segmented manner, assisted by an elastic members (e.g., bungee cords) or other methods of enticement.

For smaller gaps 96 as shown in FIG. 12, the load floor covering 98 may not need to be reinforced. The load floor covering 98 would bridge across the gap 96 without need for additional backings or support to meet specifications for a load floor. The covering 98 naturally folds down as the seat 14 is moved from the stowed position to the deployed position. If additional enticement is needed, an elastic member (e.g., one or more bungee cords) or other methods can be attached to assist in stowing the covering consistently.

FIGS. 4 and 13 show exemplary embodiments for coupling the covering to the first and second load floors. Referring to FIG. 13, a load floor system 100 includes a bin 102, a lid 104, and a load floor covering 106. A rear portion 108 of the lid 104 is coupled to a rear portion 110 of the bin 102 (e.g., by a plurality of fasteners, clips, snaps, adhesive, etc. shown as clips 112). The covering 106 is coupled to the bin 102 by one or more elastic or resilient members (shown as a bungee cord 114). One end of the bungee is connected to a lower surface (not shown in FIG. 13) of the bin 102. The other end of the bungee is coupled to the covering 106 by engaging an attachment member (e.g., bungee attachment 115) coupled to the covering 106. The bungee cord 114 has an elastic portion and a pair of mounting members 116 on each end of the elastic portion. The mounting members are cylindrical in shape and are inserted through an opening 118 on the article that the bungee cord 114 is being coupled to, and then rotated to secure it in place. The covering 106 is coupled to seatbacks 120 (which had been mounted to the row of seats) by one or more fasteners (e.g., a hook and loop or “Velcro” fastener as shown in FIG. 4, adhesive, clips, snaps, etc.). In this embodiment, the seat back (e.g., plastic, metal or other material panel) is provided to the customer along with the load floor system (e.g., rather than having the seat back panel provided separately and previously mounted on the seats). Alternatively, any of a variety of fasteners can be used such as a pressure sensitive adhesive, sinews, clips, etc. A latch releasably couples the lid and covering to the bin.

FIG. 14 shows a load floor system 130 with a continuous covering 132 folded according to an exemplary embodiment. As shown, one of the seats 14 is in an upright position and the other is in a stowed position. Covering 132 is split between the seats and is configured to fold in a predetermined arrangement.

The load floor systems shown in the Figures are configured to provide a continuous load floor (i.e., without gaps between the first load floor (e.g., primary, initial, original, etc.) and the second load floor, which is created or provided when a row of seats is folded or otherwise stowed. When the seats are in the folded or stowed position, the covering and first and second load floors provide a generally flat or planar surface. If gaps exist between the first and second load floors, structural support may be provided.

FIGS. 3 and 4 show a load floor system being mounted within a vehicle. The load floor system may be coupled to the seats before or after being installed within the vehicle. For example, the covering can be coupled to the seat back panels and seats and then the load floor system and the seat back panels and/or the seats are installed in the vehicle. The load floor system and seats can be shipped to the customer coupled together or coupled together by the customer before installation. Alternatively, the load floor system and the seats are separately installed in the vehicle (in any order or sequence) and then coupled together. FIG. 4 shows the load floor system mounted within the vehicle relative to an adjacent row of seats. The seats are folded over and the second load floor is positioned onto the seat backs so that the second load floor (i.e., seat back panel and a portion of the covering) can be coupled to the seat backs.

FIG. 1 shows the load floor system with the seats folded to provide the first load floor and the second load floor as a continuous (e.g., integrated, unitary, seamless, etc.) load floor surface. As the seats are folded from the down position to the upright position, a portion of the covering becomes disposed within the space between the seats and the initial load floor. Embodiments with supplemental support panels are moved and/or folded.

The particular materials used to construct the exemplary embodiments are also illustrative. For example, injection molded high density polyethylene is the preferred method and material for making the bases for the first and second load floors and for the storage bin. According to alternative embodiments, other materials can be used, including other thermoplastic resins such as polypropylene, other polyethylenes, acrylonitrile butadiene styrene (“ABS”), polyurethane nylon, any of a variety of homopolymer plastics, copolymer plastics, plastics with special additives, filled plastics, etc. Also, other molding operations may be used to form these components, such as injection compression molding, etc. According to a preferred embodiment, the floor panel is integrated into the structure defining the storage area (e.g., integrally formed such as by injection molding or other molding or casting operations). According to a particularly preferred embodiment, the integrated false floor structure is made of plastic such as engineered plastic products, or the like.

According to a preferred embodiment, the covering is any of a variety of carpet materials. According to alternative embodiments, the covering is any of a variety of sheets of material including plastic, textile (woven, non-woven, knit, etc.), or a variety of materials and compositions including fabric, cloth, natural material (e.g., leather, etc.), polymer (e.g., thermoplastic elastomer polyolefin (TPO), vinyl, or materials formed by reaction injection molding (RIM), etc.), elastomer, or the like or combinations thereof; and may have multiple layers (e.g., outer, inner, scrim, etc.

According to a preferred embodiment, the protective layer is a high-performance textile liner. Alternatively, any of a variety of durable and/or water/soil resistant/proof materials can be used including a flexible plastic, elastomer, rubber, etc.

It is also important to note that the construction and arrangement of the elements of the load floor system as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present inventions. Other substitutions, modifications, changes and/or omissions may be made in the design, operating conditions and arrangement of the preferred and other exemplary embodiments without departing from the spirit of the present invention as expressed in the appended claims.

What is claimed is:

1. A load floor system for a vehicle having a cargo area and a seat adjacent the cargo area, the load floor system comprising:
a first load floor located in the cargo area;
a second load floor separate from the first load floor and coupled to the seat and movable between a first position and a second position;
a covering coupled to the first load floor and to the second load floor, and configured to provide a continuous surface between the first load floor and the second load floor.

2. The load floor system of claim 1 wherein the first load floor, the second load floor, and the covering are configurable in a first storage configuration, wherein the second load floor is in the first position and storage space is provided by the first cargo floor, and a second storage configuration, wherein the second load floor is in the second position and storage space is provided by both the first cargo floor and the second cargo floor.

3. The load floor system of claim 2 wherein the first load floor and the second load floor each includes a base configured to provide structural support to the covering between the first load floor and the second load floor.

4. The load floor system of claim 2 wherein the first storage configuration is provided when the seat is in an upright position.

5. The load floor system of claim 4 wherein the second storage configuration is provided when the seat is in a stowed position.

6. The load floor system of claim 5 wherein the covering between the first load floor and the second load floor is configured to fold upon itself when the second load floor system is in the first position.

7. The load floor system of claim 5 wherein the covering between the first load floor and the second load floor is configured to fold into a gap between the first load floor and the second load floor when the second load floor is in the first position.

8. The load floor system of claim 1 wherein the covering is flexible and not configured to provide structural support between the first load floor and the second load floor when the second load floor is in the second storage position.

9. The load floor of claim 8 further comprising a third load floor-movable between a deployed position between the first load floor and the second load floor to provide structural support to the covering and a stowed position.

10. The load floor system of claim 9 wherein the third load floor comprises a bracket that pivots on a base as the second load floor moves between the first position and the second position.

11. The load floor system of claim 1 wherein the covering comprises a laminate with a structural layer to provide structural support when the second load floor is in the second position.

12. The load floor system of claim 2 wherein the second storage configurations provides expanded storage for the vehicle.

13. A vehicle interior comprising:
a seat movable between an upright position and a stowed position;
a cargo area defined at least in part by a first cargo floor;
a covering coupled to the first cargo floor and to a back surface of the seat and configured to provide a continuous surface between the first load floor and the second load floor;
wherein a first cargo configuration is provided when the seat is in the upright position;
wherein a second cargo configuration is provided when the seat is in the stowed position and the back surface of the seat is configured to provide a second load floor.

14. The load floor system of claim 13 wherein the covering is coupled to the seat by a latch and hook fastener.

15. The vehicle interior of claim 13 wherein the first load floor is pivotable between a first position and a second position to access a protective surface.

16. The vehicle interior of claim 15 further comprising a bin located below the first load floor and accessed when the first load floor is in the second position.

17. The vehicle interior of claim 15 further comprising a protective surface that is exposed when the first load floor is in the second position.

18. The vehicle interior of claim 13 wherein the seat comprises a split seat to provide a third cargo configuration wherein at least one portion of the split seat is upright and the other portion of the split seat is stowed.

19. A load floor system for a vehicle having a cargo area and a seat adjacent the cargo area, the load floor system comprising:
a first load floor located in the cargo area;
a second load floor separate from the first load floor and coupled to the seat and movable between a first position and a second position;
a covering coupled to the first load floor and to the second load floor, and configured to provide a continuous surface between the first load floor and the second load floor; and to fold upon itself at an interface between the first load floor and the second load floor when moved between the second position and the first position;
wherein the first load floor, the second load floor, and the covering are configurable in a first storage configuration, wherein the second load floor is in the first position and storage space is provided by the first cargo floor, and a second storage configuration, wherein the second load floor is in the second position and storage space is provided by both the first cargo floor and the second cargo floor.

20. The load floor system of claim 19 wherein the covering between the first load floor and the second load floor is configured to fold into a gap between the first load floor and the second load floor.

21. The load floor system of claim 19 wherein the covering is flexible and not configured to provide structural support when in the second storage condition.

22. The load floor of claim 19 further comprising a third load floor movable between a deployed position between the first load floor and the second load floor to provide support to the covering and a stowed position.

23. The load floor system of claim 19 wherein the covering comprises a structural layer to provide structural support when in the second storage condition.

24. The load floor system of claim 19 wherein the covering comprises a plurality of panels configured to pivot between a stowed position and a deployed position to provide a reconfigurable cargo management system.

25. The load floor system of claim 19 wherein one or more panels are pivoted about a hinge formed by the covering.
